(19) United States
(12) Patent Application Publication
(10) Pub. No.: US 2001/0028397 A1
(43) Pub. Date: Oct. 11, 2001

(54) Camera

(75) Inventor: Kenji Nakamura, Takatsuki-shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD

(21) Appl. No.: 09/821,442

(22) Filed: Mar. 29, 2001

(30) Foreign Application Priority Data
Mar. 31, 2000 (JP) 2000-097389

(51) Int. Cl. H04N 5/228

(52) U.S. Cl. 348/222; 348/333.01; 348/552

(57) ABSTRACT

In a digital camera, an image data of an object is taken by an image pickup device, the image data is processed predetermined data processes such as white balance adjustment, data compression and extension, γ compensation, and contour emphasizing, and the image data is communicated between the digital camera and another electronic equipment such as a personal computer. Data processors and communication interface are respectively configured by a common FPGA (Field Programmable Gate Array) which can serve as plural kinds of dedicated circuits by witting different programs. In image pickup mode, a compression program is automatically written in the FPGA for serving as a JPEG data compressor. Alternatively, in reproducing mode, an extension program is written in the FPGA for serving as a JPEG data extender. When an RS-232C cable is connected to a connector of the digital camera, an RS-232C program is automatically written in the FPGA for serving as an RS-232C interface. Alternatively when a USB cable is connected, a USB program is automatically written in the FPGA for serving as a USB interface.

This application is based on patent application 2000-097389 filed in Japan, the contents of which are hereby incorporated by references.

### BACKGROUND OF THE INVENTION

1. Field of the Invention

The present invention relates to a camera which can communicate with another electronic equipment such as a personal computer.

2. Description of the Related Art

In a camera such as a digital camera, an optical image of an object is focused on a surface of an image pickup device, and light energy corresponding to the optical image is transferred to electric energy by photoelectric transfer in each pixel of the image pickup device. An image data corresponding to the image focused on the image pickup device is constituted by electric signals from the pixels. The image data is processed with a predetermined signal processing such as white balance adjustment by a CPU (Central Processing Unit) with a processing program therefor. After the signal processing, the image data is recorded in an recording medium such as a detachable memory card.

In recent years, a number of pixels of the image pickup device is largely increased, so that it is necessary to compress the image data for increasing a number of image data to be recorded in the memory card. The compression of the image data is executed by the CPU with the program therefor or by a dedicated integrated circuit called ASIC (Application Specific Integrated Circuit) in the digital camera. Furthermore, when the image recorded in the memory card is reproduced, the compressed image data will be extended by the CPU or the ASIC.

When the compression and extension of the image data are executed by the CPU with the program, it occupies much time for data processing of the image data. Alternatively, when the compression and extension of the image data are executed by the ASIC, the processing time of the image data becomes shorter than that in the above-mentioned case, but a lot of circuit elements are necessary for configuring the ASIC corresponding to the increase of the number of pixels of the image pickup device, so that the ASIC or the digital camera containing the ASIC will be upsized. Thus, it is desired to provide a method or a mechanism for processing the compression and extension of the image data in a short time by the ASIC without upsizing the digital camera.

On the other hand, the digital camera generally has an interface for communicating with another electronic equipment such as a personal computer. In recent years, kinds of the interfaces for communicating between the digital camera and the personal computer are multiplied, so that it is preferable to provide several kinds of the interfaces in the digital camera as much as possible.

However, when a plurality of interfaces are realized by programs, it occupies much time for communicating the image data between the digital camera and the personal computer. Alternatively, when the interfaces are realized by a dedicated IC (Integrated Circuit), the IC needs a lot of circuit elements for constituting the IC, so that the upsizing of the digital camera will be inevitable.

### SUMMERY OF THE INVENTION

A purpose of the present invention is to provide a camera by which data processing such as compression and extension of the image data can be executed in a short time without upsizing the camera.

A camera in accordance with an aspect of the present invention comprises: a mode selector for selecting one of a first mode for executing a first image data processing to an image data taken by an image pickup device and a second mode for executing a second image data processing contents of which are different from that of the first image data processing; a calculator in which a logic circuit for executing a predetermined operation to an inputted image data when a predetermined program is written; a memory for memorizing a first program corresponding to the first image data processing and a second program corresponding to the second image data processing; and a controller for reading the first program from the memory and writing it in the calculator when the first mode is selected by the mode selector and for reading the second program from the memory and writing it in the calculator when the second mode is selected by the mode selector.

By such a configuration, the same calculator can be used as alternative of a logic circuit fitting to the first image data processing when the first image data processing is selected and another logic circuit fitting to the second image data processing when the second image data processing is selected. The calculator can be configured by, for example, a programmable gate array such as FPGA (Field Programmable Gate Array), so that processing speed of the image data processing can be fastened than that executed by a CPU with a predetermined image processing program. Furthermore, the same calculator can be used two logic circuits, so that the circuit configuration can be made simple.

### BRIEF DESCRIPTION OF THE DRAWINGS

FIG. 1 is a front view for showing an appearance of a digital camera which is an embodiment of an electronic camera in accordance with the present invention;

FIG. 2 is a rear view of the digital camera;

FIG. 3 is a bottom view of the digital camera;

FIG. 4 is a right side view of the digital camera;

FIG. 5A is a front view for showing an example of an image displayed on a monitor display of the digital camera using an image data taken by an image pickup device in image pickup mode in the embodiment;

FIG. 5B is a front view for showing an example of an image reproduced on the monitor display using an image data recorded in a memory card in reproducing mode in the embodiment;

FIG. 5C is a front view for showing an example of a menu n image displayed on a monitor display of the digital camera in menu mode in the embodiment;

FIG. 6 is a schematic view for showing a data communication between the digital camera and another electronic equipment such as a personal computer;

FIG. 7 is a front view for showing an arrangement of terminals of a connector of the digital camera in the embodiment;

FIG. 8 is a block diagram showing a configuration of the digital camera in the embodiment;

FIG. 9 is a schematic view for showing a configuration of an image data recorded in the memory card in the embodiment;

FIG. 10 is a flowchart showing an operation of the digital camera in the embodiment;

FIG. 11 is a flowchart showing an operation of the digital camera in PC mode in the embodiment;

FIG. 12 is a block diagram showing a modified configuration of the digital camera in the embodiment;

FIG. 13 is a graph for showing characteristic curves for γ compensation of the image data in the modification of the embodiment;

FIGS. 14A to 14E are tables for showing arrangements of filtering coefficients used for contour emphasizing compensation of the image when compression ratio K=⅛ in the modification of the embodiment;

FIGS. 15A to 15E are tables for showing arrangements of filtering coefficients used for contour emphasizing compensation of the image when compression ratio K=1/20 in the modification of the embodiment; and

FIG. 16 is a table for showing an arrangement of the filtering coefficients in the modification of the embodiment.

### DETAILED DESCRIPTION OF THE EMBODIMENT

An embodiment the present invention is described. In the description of the embodiment, “right” and “left” are standardized by a user observing a viewfinder of the digital camera.

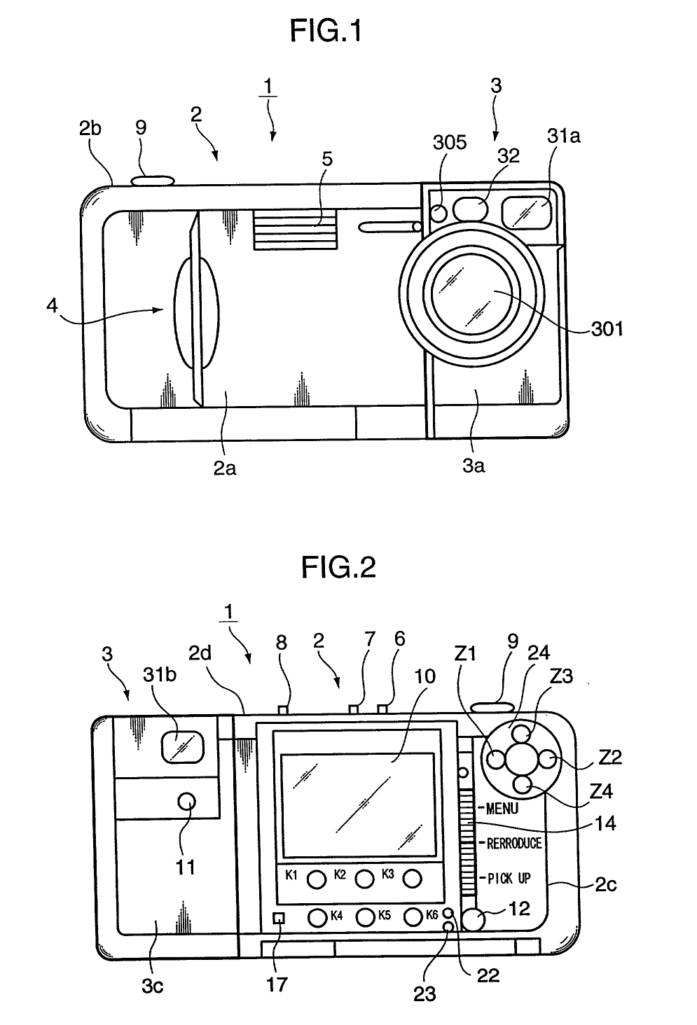

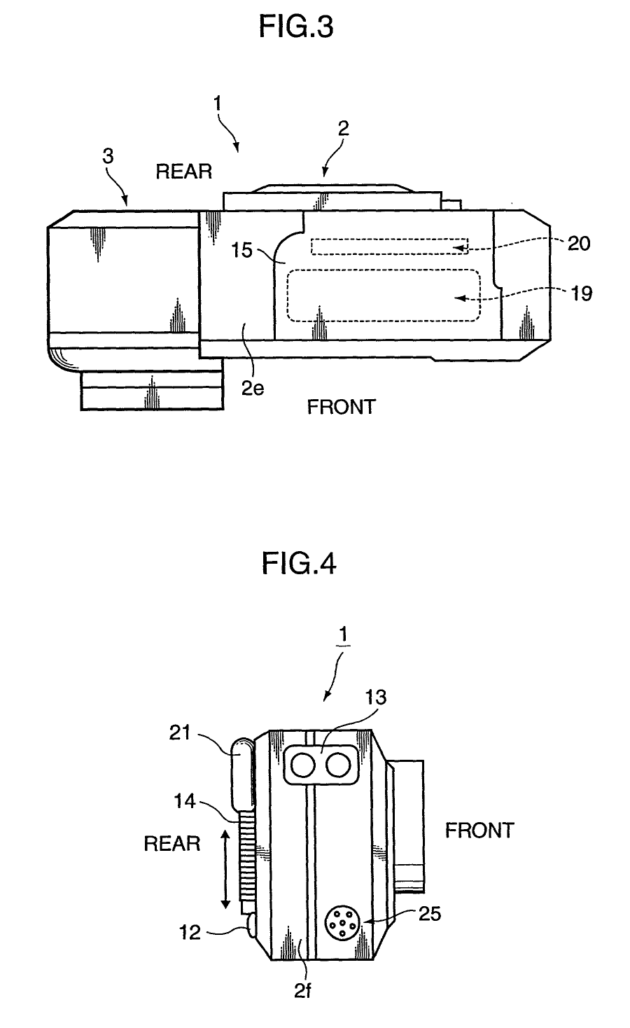

FIG. 1 is a front view of a digital camera which is the embodiment of the electronic camera in accordance with the present invention. FIG. 2 is a rear view of the digital camera. FIG. 3 is a right side view of the digital camera. FIG. 4 is a bottom view of the digital camera.

As can be seen from the figures, the digital camera 1 is configured by a box-shaped camera body 2 and an image pickup unit 3 detachably coupled with the left side of the camera body 2.

As shown in FIG. 1, a flash device 5 is disposed at upper center portion on a front face 2a of the camera body 2. A holding grip 4 is provided at right side on the front face 2a of the camera body 2. A shutter start switch 9 is provided in the vicinity of the right end on an upper face 2b of the camera body 2.

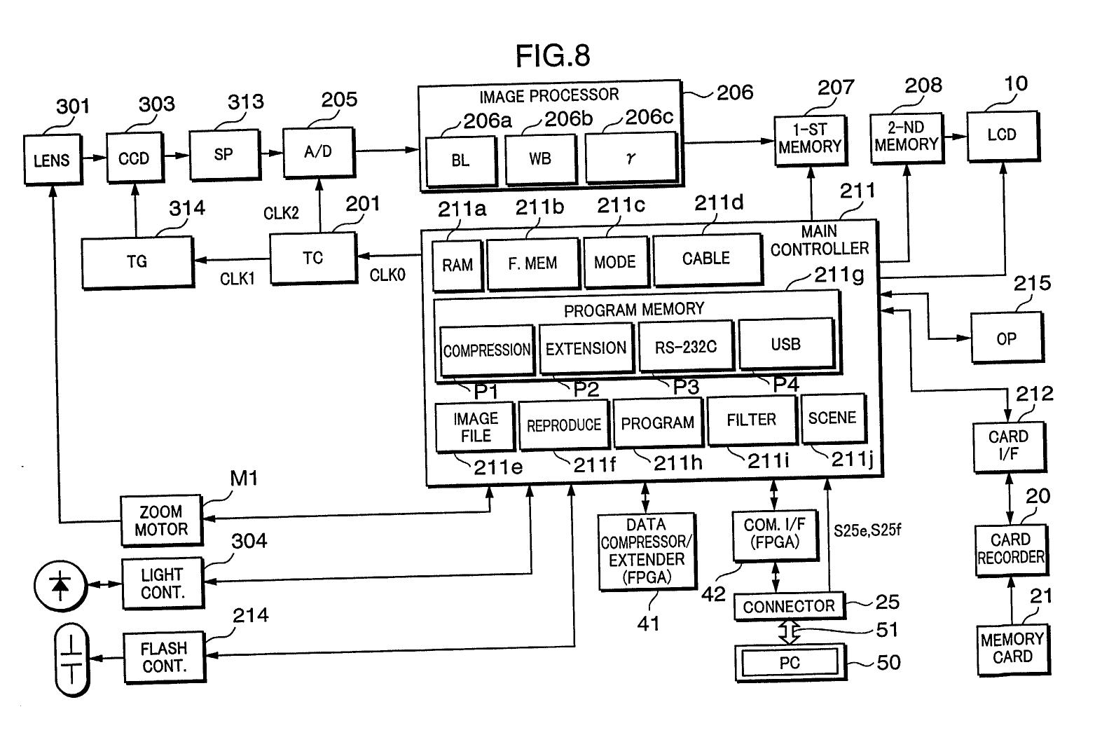

A taking lens 301 such as a zoom lens is provided substantially at the center of a front face 3a of the image pickup unit 3. An image pickup device 303 (see FIG. 8) such as CCD (Charge Coupled device) is provided on an optical axis of and behind the taking lens 301, which is not shown in FIGS. 1 to 4. An optical image of an object is focused on a surface of the image pickup device 303 by the taking lens 301. Light energy of the optical image is converted to electric signals by pixels of the image pickup device 303, which are configured by two-dimensional arrangement of photoelectric transducers such as phototransistors. Thus, the optical image of the object is taken as an image data constituted by electric signals such as electric charges of the pixels of the image pickup device 303.

An objective window 31a of an optical viewfinder is provided at upper left position on the front face 3a with respect to the taking lens 301. A focusing window 32 of an automatic focusing module (hereinafter abbreviated as AF module) is provided at upper center on the front face 3a of the image pickup unit 3. A sensor of the AF module (which is not shown in the figure) for sensing a distance to an object from the camera is disposed behind the focusing window 32. The sensor of the AF module receives a light reflected from an object through the focusing window 32 and a processor of the AF module calculates a distance to the object by using an output signal from the sensor.

A window for a photo-sensor 305 is provided at upper right on the front face 3a. The photo-sensor 305 such as an SPC (Silicon Photo Cell) senses a reflected light of a flash light reflected from the object for controlling a quantity of flash light of the flash device 5.

As shown in FIG. 2, a monitor display 10 such as an LCD (liquid Crystal Display) is provided substantially at the center on a rear face 2c of the camera body 2. The monitor display 10 displays not only a monitor image for serving as an electrical viewfinder but also a reproduced still picture image which is, for example, recorded in a memory card 21 (see FIG. 8). Furthermore, the monitor display 10 displays menus of operations which can be executed in the digital camera 1. The monitor display 10 is driven by, for example, NTSC video signals.

An LCD switch 11 is provided below an eyepiece 31b of the optical viewfinder on a rear face 3c of the image pickup unit 3 for switching on and off of the monitor display 10. When the optical image of the object is observed by using only the optical viewfinder for saving electricity, the monitor display 10 is switched off by pushing the LCD switch 11. The monitor display 10 is switched on and off when the LCD switch 11 is cyclically pushed one by one.

A quadruplet switch 24 is provided at upper right portion on the rear face 2c of the camera body 2. The quadruplet switch 24 is a multifunctional switch including four push switches Z1 to Z4. The switches Z1 and Z2 are zooming switches used for varying a focal length of the taking lens 301. While the switch Z1 has been pushed on, a zooming motor M1 (see FIG. 8) is driven for moving a zooming lens group of the taking lens 301 in a manner so that the focal length of the taking lens 301 becomes shorter or an angular field of view of the taking lens 301 becomes wider. Alternatively, while the switch Z2 has been pushed on, the zooming motor M1 is driven for moving the zooming lens group of the taking lens 301 in a manner so that the focal length of the taking lens 301 becomes longer or the angular field of view of the taking lens 301 becomes narrower.

The switches Z3 and Z4 are exposure compensation switches used for compensating exposure condition to be desirable by manual operation. When the switch Z3 is pushed on one by one, the exposure condition is changed to be surplus by a predetermined light quantity. Alternatively, when the switch Z4 is pushed on one by one, the exposure condition is changed to be deficient by a predetermined light quantity.

Since the switches Z1 to Z4 are integrated in the quadruplet switch 24, it is possible to operate these switches Z1 to Z4 by a single finger, for example, thumb of right hand. Thus, handling of the digital camera 1 can be made smooth.

A plurality of switches K1 to K6 used for selecting several kinds of operations of the digital camera 1 and a power switch 12 are provided below the monitor display 10. A first indicator 22 and a second indicator 23 such as LEDs (Light Emitting Diode) are provided at left side of the power switch 12. While the first indicator 22 has been lit, it shows that the power switch 12 is switched on. When the second indicator 23 is lit, it shows that a memory card 21 inserted into a memory card recorder 20 in the digital camera 1 is accessed.

Frame selection switches 6 and 7 used for selecting a picture frame to be reproduced on the monitor frame 10 are provided at a top surface 2d of the main body 2. When the switch 6 is pushed on one by one, the image reproduced on the monitor display 10 is serially renewed from top to end of frame numbers of the image data recorded in the memory card 21. Alternatively, when the switch 7 is pushed on one by one, the image reproduced on the monitor display 10 is serially renewed from end to top of frame numbers of the image data recorded in the memory card 21. Furthermore, an erasing switch 8 used for erasing the image data recorded in the memory card 21 is provided at the left side of the frame selection switch 7.

The above-mentioned shutter start switch 9 includes a first switch S1 and a second switch S2. The first switch S1 is switched on when the user touches the upper surface of the shutter start switch 9 or when the user pushes down the shutter start switch 9 by a predetermined depth. The second switch S2 is switched on when the user fully pushes down the shutter start switch 9. When the first switch S1 is switched on, the image pickup unit 3 takes an image data of an optical image to be displayed on the monitor display 10 serving as a viewfinder at an interval, for example, 1/30 sec and decides an exposure condition corresponding to the image data (standby mode). When the second switch S2 is switched on, the image pickup unit 3 will take an image data to be recorded in the memory card 21.

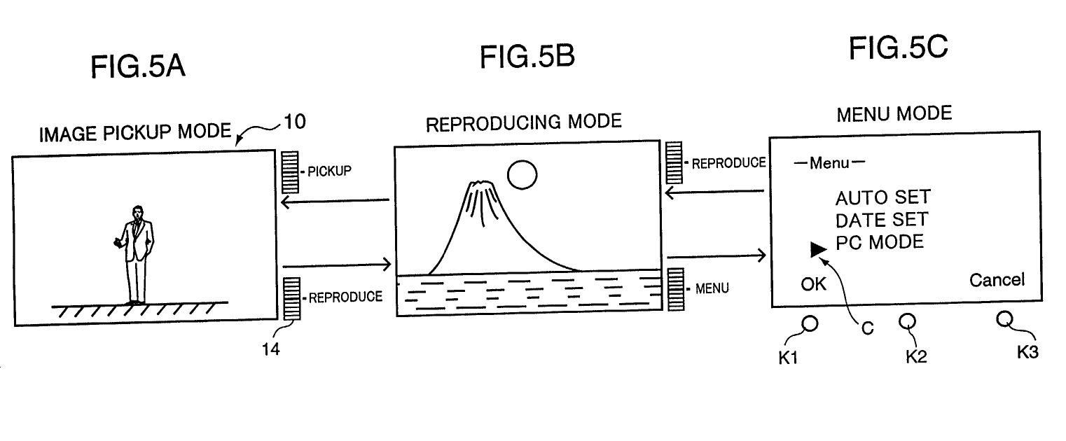

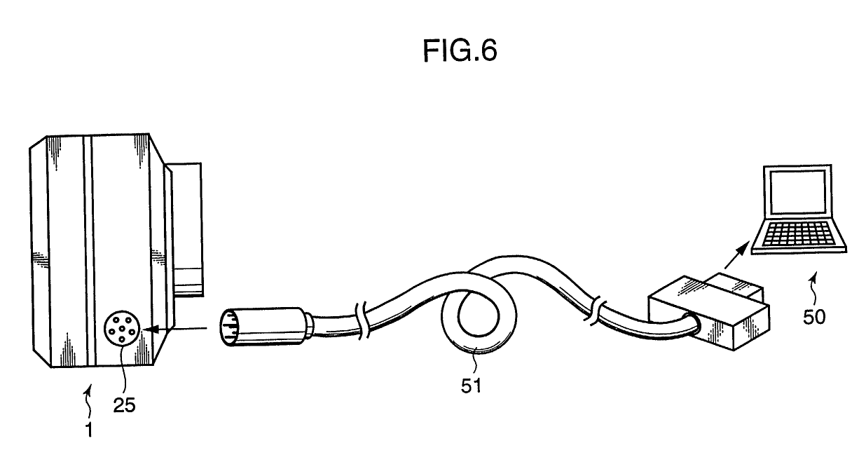

A longitudinally oblong sliding switch 14 for setting the mode of the digital camera 1 is provided along the right side of the monitor display 10. The sliding switch 14 has three positions corresponding to “image pickup mode”, “reproducing mode” and “menu mode” of the digital camera 1. In the image pickup mode shown in FIG. 5A, an optical image of an object can be taken as an image data. In the reproducing mode shown in FIG. 5B, an image is reproduced on the monitor display 10 by using an image data recorded in the memory card 21. In the menu mode shown in FIG. 5C, several menus of functions which can be executed in the digital camera 1 are displayed on the monitor display 10, and one of them can be selected by switching operation of the switches K1 to K6. “PC mode” by which the image data can be communicated between the digital camera 1 and an image processing equipment such as a personal computer 50 (see FIG. 6) is included in the menus.

A compression ratio setting switch 17 is provided at left side of the switches K1 to K6. When the switch 17 is pushed one by one, a compression ratio by which the image data to be recorded in the memory card 21 is compressed is cyclically changed among predetermined values.

As shown in FIG. 3, a memory card recorder 20 to which the memory card 21 is inserted and a battery cavity 19 to which the batteries are filled are provided substantially at the center of the bottom of the camera body 2. A clamshell type lid 15 is hinged at a bottom face 2e of the camera body 2 for covering the memory card recorder 20 and the battery cavity 19.

As shown in FIG. 4, a DC inlet 13 and a connector 25 are provided on a right side 2f of the camera body 2. As shown in FIG. 6, a communication cable 51 such as an RS-232C cable or a USB (Universal Serial Bus) cable can be connected to the connector 25, so that the data communication between the digital camera 1 and the personal computer 50 can be realized.

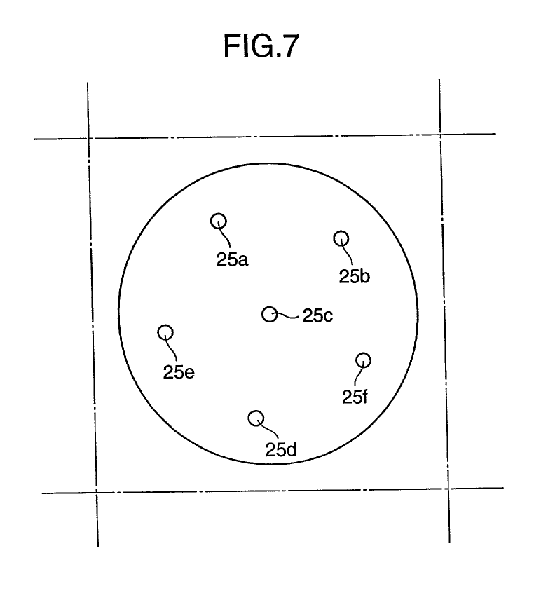

The connector 25 is usable for both of the RS-232C cable and the USB cable. As shown in FIG. 7, the connector 25 has six female terminals 25a to 25f. Four terminals 25a to 25d are commonly used for both of the RS-232C cable and the USB cable. The terminal 25e is used for the RS-232C cable and the terminal 25f is used for the USB cable. When the RS-232C cable is connected to the connector 25, a signal corresponding to “1” or “high” is outputted from a male terminal to be engaged with the female terminal 25e, and the potential of the terminal 25f corresponds to “0” or “low”. Alternatively, when the USB cable is connected to the connector 25, a signal corresponding to “1” or “high” is outputted from a male terminal to be engaged with the female terminal 25f, and the potential of the terminal 25e corresponds to “0” or “low”. By watching the potentials of the signals (S₂₅ₑ, S_{25f}) from the terminals 25e and 25f, it can be found which of the RS-232C cable and the USB cable is connected to the connector 25. Concretely, when the signals (S₂₅ₑ, S_{25f}) are (1, 0), it is judged that the RS-232C cable is connected. Alternatively, when the signals (S₂₅ₑ, S_{25f}) are (0, 1), it is judged that the USB cable is connected.

A block diagram of the digital camera 1 of this embodiment is shown in FIG. 8. In FIG. 8, the same numerals used in FIGS. 1 to 7 designate the same elements.

As mentioned above, the image pickup device (CCD) 303 is disposed on a focal plane of the taking lens (LENS) 301, the pixels of the image pickup device 303 respectively photo-electrically transfer the optical energy of an optical image to the electric signals such as electric charges with respect to each pixels. When clock signals are inputted to the image pickup device 303, the electric signals sensed by the pixels are serially outputted from the image pickup device 303. In this embodiment, the digital camera 1 has a single image pickup device 303, so that the pixels of the image pickup device 303 are respectively distributed to one of three primary colors of R (Red), G (Green) and B (Blue).

In this embodiment, an aperture stop of the taking lens 301 is fixed, so that exposure of the digital camera 1 is controlled by varying charge storage time (exposure time) of the image pickup device 303. When luminance of an object is too low to set a proper exposure time, level of the electric signals outputted from the image pickup device 303 is amplified so as to compensate the underexposure.

A timing generator (TG) 314 generates a plurality of kinds of driving control signals of the image pickup device 303 by using a clock signal CLK1 outputted from a timing controller (TC) 201. The driving control signals includes timing signals for controlling start and finish the charge storage of the image pickup device 303 and the above-mentioned clock signals such as horizontal synchronizing signal, vertical synchronizing signal and transfer signal for outputting the pixel data from the pixels of the image pickup device 303.

A signal processor (SP) 313 executes predetermined analog signal processing to the electric signals outputted from the image pickup device 303. The signal processor 313 has functions for reducing noise contained in the pixel data and for adjusting (amplifying) the level of the electric signals by adjusting the gain.

An A/D converter (A/D) 205 converts the processed analogous electric signals outputted from the signal processor 313 to ten-bits digital signals corresponding to a clock signal CLK2 for A/D conversion inputted from the timing controller 201, and inputs the converted digital electric signals to an image processor 206. Hereinafter, the converted digital electric signals are called “pixel data”.

The timing controller 201 generates the clock signals CLK1 and CLK2 by using a standard clock signal CLKO outputted from a main controller 211, and inputs them to the timing generator 314 and the A/D converter 205, as mentioned above.

The image processor 206 includes a black level compensation circuit (BL) 206a, a white balance circuit (WB) 206b, a γ compensation circuit (γ) 206c. The black level compensation circuit (BL) 206a compensates the level of black of the pixel data to a predetermined standard black level. The white balance circuit 206c converts the levels of the pixel data with respect to color components of R, G and B by using a predetermined level conversion table inputted from the main controller 211 in a manner so that the white balance of the image taken by the image pickup device 303 will be compensated to be predetermined level after the γ compensation. Coefficients in the level conversion table with respect to each color component is set by the main controller 211 in each image pickup operation. The γ compensation circuit 206c compensates the γ characteristics of the pixel data by using a predetermined γ compensation table. The compensated pixel data is inputted to a first image memory 207.

The first image memory 207 memorizes not only the pixel data outputted from the γ compensation circuit 206 c in the image pickup mode, but also an image data readout from a memory card 21 in the reproducing mode. The image memory 207 has a capacity sufficient to store the pixel data of one frame. Each pixel data is stored at a memory position having the same address as the position of the pixel.

Hereupon, the image data which is recorded in the memory card 21 is distinguished from the pixel data, since the image data is the final stage that predetermined data processing is processed to the pixel data.

A second image memory 208 is a buffer memory for memorizing an image data used for reproducing an image on the monitor display (LCD) 10, and has a capacity sufficient to memorize the image data corresponding to the number of pixels of the monitor display 10.

When the digital camera 1 is in the standby mode of the image pickup operation, an optical image of an object is taken by the image pickup device 303 at an interval of 1/30 sec, and the exposure condition is renewed at each time. The pixel data which is processed the predetermined signal processing by the A/D converter 205 and the image processor 206 is memorized in the first image memory 207. Further more, the pixel data is transmitted to the second image memory 208 through the main controller 211, and the image of the object is displayed on the monitor display 10 by using the pixel data memorized in the second image memory 208. By such the operations, the user can observe the image of the object displayed on the monitor display 10.

In the reproducing mode, an image data readout from a memory card 21 is memorized in the first image memory 207. The image data memorized in the first image memory 207 is processed the predetermined image processing by the main controller 211 and transmitted to the second image memory 208 for being memorized therein. After that, the image is reproduced on the monitor display by using the image data memorized in the second image memory 208.

A card interface (CARD I/F) 212 is an interface for writing the processed pixel data as an image data in the memory card 21 and for reading the image data from the memory card 21 which is inserted into the card slot of the memory card recorder 20.

A communication interface (COM. I/F) 42 is an interface for communicating the image data between the digital camera 1 and the personal computer (PC) 50. In this embodiment, the digital camera 1 can be connected to the personal computer 50 by the communication cable 51 such as an RS-232C cable or a USB cable connected with the connector 25, so that an image can be reproduced on a monitor display of the personal computer 50 by using an image data recorded in the memory card 21, and predetermined image processing can be processed to the image data transmitted to the personal computer 50.

A light controller 304 controls a quantity of flash light emitted from the flash device 5 corresponding to a predetermined quantity which is inputted from the main controller 211. In the image pickup operation with the flash light, reflected light of the flash light from an object is received by the photo-sensor 305 at the same time of starting the exposure of the image pickup device 303. When the quantity of the reflected light received by the photo-sensor 305 reaches to the predetermined quantity, the light controller 304 outputs a stop signal for stopping the flash lighting to a flash controller 214. The flash controller 214 is a circuit for controlling start and stop of a lighting of flash light. When the stop signal is inputted, the flash controller 214 forcibly stops the flash lighting of the flash device 5. Thereby, the quantity of flash light of the flash device 5 is controlled.

The frame selection switches 6 and 7, the erasing switch 8, the shutter start switch 9, the sliding switch 14 and the quadruplet switch 24 configure an operation section (OP) 215.

The main controller 211 comprises a microprocessor for concentratively controlling the image pickup operation of the digital camera 1 by controlling the elements in the camera body 2 and the image pickup unit 3, a RAM 211 a serving as a working space in the microprocessor and a flash memory (F-MEM.) 211b memorizing a program executed in the microprocessor.

The main controller 211 includes a mode judging portion (MODE) 211c for judging the selected mode of the function and a cable judging portion (CABLE) 211d for judging the kind of the communication cable 51 connected with the connector 25. The mode judging portion 211c and the cable judging portion 211d are realized by the microprocessor, RAM 211a, flash memory 211b, and so on. The following portions described below will be realized the same manner. The mode judging portion 211c judges which of the above-mentioned image pickup mode, reproducing mode and PC mode is selected by the user. The cable judging portion 211d judges which of the RS-232C cable and the USB cable is connected with the connector 25 by sensing the signals (S₂₅ₑ, S_{25f}) inputted into the terminals 25e and 25f of the connector 25. When the signals (S₂₅ₑ, S_{25f}) are (1, 0), it judges that the RS-232C cable is connected. Alternatively, when the signals (S₂₅ₑ, S_{25f}) are (0, 1), it judges that the USB cable is connected.

The main controller 211 further includes an image file forming portion (IMAGE FILE) 211e for forming an image file to be recorded in the memory card 21 and an image reproducing portion (REPRODUCE) 211f for reproducing an image on the monitor display 10 by reading the image data recorded in the memory card 21.

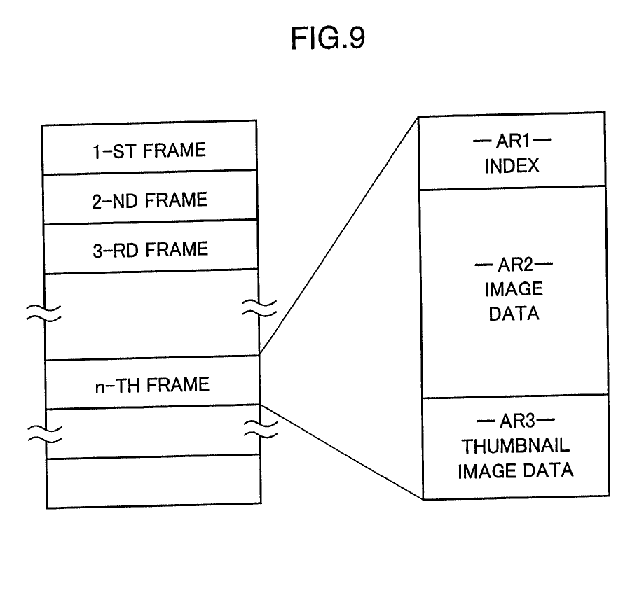

As shown in FIG. 9, a plurality of image files are recorded in the memory card 21 in time sequence. The image file corresponding to each frame is configured by three areas AR1, AR2 and AR3. An index information including frame number, exposure value, exposing time, compression ratio, date, on/off of the flash, information with respect to the scene such as location, judgement of the image, and so on is recorded in the first area AR1. A compressed image data of the pixel data memorized in the first image memory 207 by JPEG (Joint Photographic coding Experts Group) method is recorded in the second area AR2 (hereinafter, the compressed image data is called “JPEG image data”). A thumbnail image data which is formed from the pixel data in the first image memory 207 is recorded in the third area AR3.

The JPEG image data is formed by a data compressor/extender 41 when it serves as a data compressing circuit. When the data compressor/extender 41 serves as the data compressing circuit, it reads out all the pixel data from the first image memory 207 and processes predetermined data compression processing of JPEG method such as two-dimensional DCT conversion and Huffman coding to the pixel data. Thus, the JPEG image data is obtained.

The thumbnail image data is formed by the above-mentioned image file forming portion 211e. The image file forming portion 211e picks the pixel data at an interval of eight pixels in the horizontal direction and at an interval of eight lines in the vertical direction along the raster scanning way from the data stored in the first image memory 207. Thus, the thumbnail image data is formed.

The image reproducing portion 211f reproduces the image or the thumbnail images on the monitor display 10 by using the JPEG image data or the thumbnail image data recorded in the memory card 21. When the JPEG image data is readout from the memory card 21, it is extended by the data compressor/extender 41 serving as a data extension circuit.

By the way, the compression of the pixel data is executed in the image pickup mode, and the extension of the JPEG image data is executed in the reproducing mode. In other words, the compression and the extension of the image data never be executed at the same time. Thus, in this embodiment, the data compressor/extender 41 is realized by a common FPGA (Field Programmable Gate Array).

In the FPGA, a lot of function or logic modules, namely, CLBs (Configurable Logic Blocks) are regularly arranged and each CLB can be connected to another CLB by wiring resources. Function of the CLB or a relation between the input signals and the output signals can be decided by inputting data into a function generator such as a RAM provided in the CLB. Connection pattern of the CLBs can be decided by controlling the wiring resources. Thus, the generalized FPGA can be used as a gate array serving as a predetermined function by entering a predetermined program.

In this embodiment, a compression program (COMPRESSION) P1 which enables the data compressor/extender 41 to serve as the data compression circuit in the image pickup mode and an extension program (EXTENSION) P2 which enables the data compressor/extender 41 to serve as the data extension circuit in the reproducing mode are prepared. The compression program P1 and the extension program P2 are alternatively inputted into the FPGA, so that the data compressor/extender 41 can alternatively serve as the data compression circuit and the data extension circuit.

The main controller 211 comprises a program memory 211g and serve as a program selecting portion (PROGRAM) 211h. The program memory 211g memorizes the compression program P1, the extension program P2, and so on. When the mode judging portion 211c judges that the image pickup mode is selected by the user, the program selecting portion 211h selects the JPEG data compression program P1 and enters it into the data compressor/extender (FPGA) 41. Thus, the data compressor/extender 41 serves as the data compression circuit. Alternatively, when the mode judging portion 211c judges that the reproducing mode is selected by the user, the program selecting portion 211h selects the JPEG data extension program P2 and enters it into the data compressor/extender 41. Thus, the data compressor/extender 41 serves as the data extension circuit.

On the other hand, the RS-232C cable and the USB cable can alternatively be connected to the same connector 25 in this embodiment. In other words, the RS-232C interface and the USB interface never be communicative at the same time. Thus, the communication interface 42 is realized by a common FPGA for serving as alternative of an RS-232C interface and a USB interface, in this embodiment. An RS-232C program (RS-232C) P3 which enables the communication interface 42 to serve as the RS-232C interface and a USB program (USB) P4 which enables the communication interface 42 as the USB interface are prepared and memorized in the program memory 211g.

When the mode judging portion 211c judges that the PC mode is selected by the user, the program selecting portion 211h selects one of the RS-232C program P3 and the USB program P4 corresponding to the judgement of the cable judging portion 211d, and enters the selected program P3 or P4 into the communication interface 42. When the cable judging portion 211d judges that the RS-232C cable is connected to the connector 25, the program selecting portion 211h selects the RS-232C program P3 and enters it into the communication interface 42. Thus, the communication interface 42 serves as the RS-232C interface. Alternatively, when the cable judging portion 211d judges that the USB cable is connected to the connector 25, the program selecting portion 211h selects the USB program P4 and enters it into the communication interface 42. Thus, the communication interface 42 serves as the USB interface.

The main controller 211 further includes a digital filtering circuit (FILTER) 211i for compensating quality of the image with respect to the contour of the image by filtering a high frequency component in the image data to be recorded. The main controller 211 still further includes a scene judging portion (SCENE) 211j for judging the scene of the image or photographing corresponds to which of “low light level scene”, “middle light level normal scene”, “middle light level rear light scene” and “high light level scene” so that proper exposure time, γ compensation and filtering can be set.

In the low light level scene, a luminance of an object is too low to take a photograph without using an auxiliary light, for example, when the photograph is taken in a room or at night. In the middle light level normal scene, a luminance of an object is proper to take a photograph without using an auxiliary light, and the main object is illuminated by the follow light including natural light and artificial light. In the middle light level rear light scene, a mean luminance of the object is proper, but the main object is illuminated by the rear light, so that it is preferable to use the auxiliary light. In the high light level scene, a luminance of the object is very high, for example, when the photograph is taken on the clear beach or on the snowfield.

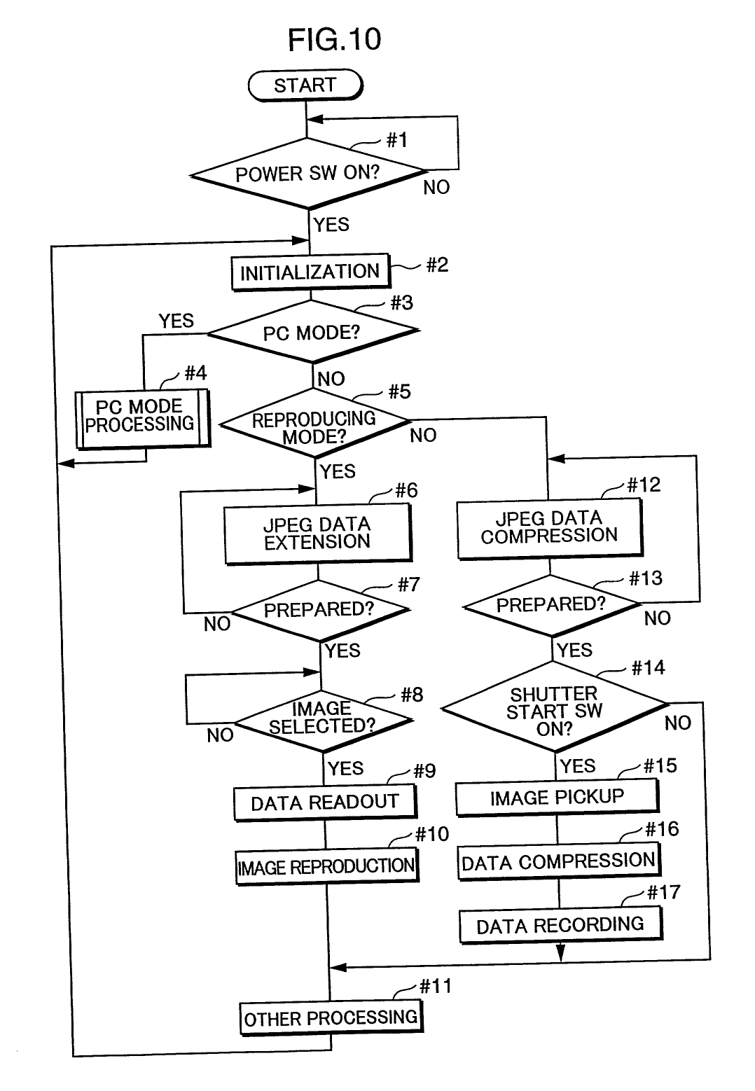

Operations of the digital camera in accordance with this embodiment is described referring to a flowchart shown in FIG. 10. In FIG. 10, the switches are abbreviated as “SW”.

When the power switch 12 of the digital camera 1 is switched on by the user (Step #1), the main controller 211 initializes each functional element (Step #2). After that, the mode judging portion 211c judges whether the PC mode is selected or not (Step #3). When the PC mode is selected, the main controller 211 executes the PC mode processing which will be described below (Step #4). When the PC mode is not selected, the mode judging portion 211c judges whether the reproducing mode is selected or not (Step #5).

When the reproducing mode is selected, the program selecting portion 211h selects the JPEG data extension program P2 from the program memory 211g and enters it into the data compressor/extender 41 so as to serve as the data extension circuit (Step #6). Subsequently, the main controller 211 judges whether the data compressor/extender 41 is prepared to serve as the data extension circuit or not (Step #7). When the data compressor/extender 41 is set to serve as the data extension circuit, the main controller 211 waits that the user select the image to be reproduced (Step #8). When the image to be reproduced is selected by the user, the image reproducing portion 211f readouts the image data corresponding to the selected image from the memory card 21 (Step #9), and reproduces an image on the monitor display 10 by using the selected image (Step #10). Subsequently, the main controller 211 executes another processing (Step #11).

On the other hand, when the reproducing mode is not selected in the step #5, in other words, the image pickup mode is selected, the program selecting portion 211h selects the JPEG data compression program P1 from the program memory 211g and enters it into the data compressor/extender 41 so as to serve as the data compression circuit (Step #12). Subsequently, the main controller 211 judges whether the data compressor/extender 41 is prepared to serve as the data compression circuit or not (Step #13). When the data compressor/extender 41 is set to serve as the data compression circuit, the main controller 211 waits that the shutter start switch 9 is fully pushed on by the user (Step #14). When the shutter start switch 9 is fully pushed, the main controller 211 controls the image pickup device 303 for taking an optical image of an object (Step #15). Subsequently, the data compressor/extender 41 compresses the image data taken by the image pickup device 303 (Step #16), and the compressed image data is recorded in the memory card 21 (Step #17). Subsequently, the main controller 211 executes another processing (Step #11).

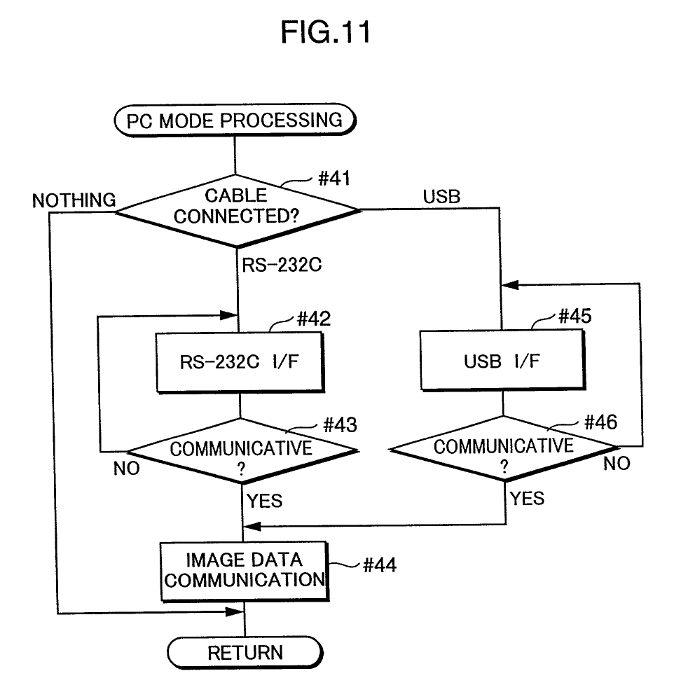

The PC mode in step #4 in FIG. 10 is described with reference to a flowchart shown in FIG. 11. In the PC mode, it is judged whether any cable is connected with the connector 25 or not, at first. When the cable is connected with the connector 25, the kind of the cable is subsequently judged (Step #41). The judgement is executed by using the signals (S₂₅ₑ, S_{25f}).

When the cable judging portion 211c judges that the RS-232C cable is connected by sensing the signals (1, 0), the program selecting portion 211h selects the RS-232C program P3 from the program memory 211g and enters into the communication interface 42 so as to serve as the RS-232C interface (Step #42). After that, the main controller 211 judges whether the communication interface 42 is communicative or not with other electronic equipment such as the personal computer 50 (Step #43). When the communication interface 42 is communicative with the personal computer 50, the main controller 211 communicates the image data with the personal computer 50 (Step #44).

Alternatively, when the cable judging portion 211c judges that the USB cable is connected by sensing the signals (0, 1), the program selecting portion 211h selects the USB program P4 from the program memory 211g and enters into the communication interface 42 so as to serve as the USB interface (Step #45). After that, the main controller 211 judges whether the communication interface 42 is communicative or not with other electronic equipment such as the personal computer 50 (Step #46). When the communication interface 42 is communicative with the personal computer 50, the main controller 211 communicates the image data with the personal computer 50 (Step #44).

As mentioned above, the data compressor/ extender 41 for compressing and expanding the image data is configured by the FPGA, the data compressor/extender 41 is used as the data compressing circuit when the image pickup mode is selected, and the data compressor/extender 41 is used as the data extension circuit when the reproducing mode is selected. Thus, it is possible that processing speed in this embodiment can be made faster than that in the conventional data processing by the software program. Alternatively, it is possible that the circuit configuration used for the data compression and extension in this embodiment can be made simpler than that in the conventional circuits configured by the dedicated ICs.

Furthermore, the communication interface 42 for communicating with another electronic equipment is configured by the FPGA, the communication interface 42 is used as the RS-232C interface when the RS-232C cable is connected with the connector 25, and the communication interface 42 is used as the USB interface when the USB cable is connected with the connector 25. Thus, it is possible that processing speed of the communication interfaces in this embodiment can be made faster than that in the conventional communication interface by the software program. Alternatively, is possible that the circuit configuration used for the communication interfaces in this embodiment can be made simpler than that in the conventional circuits configured by the dedicated ICs.

In the above-mentioned embodiment, the image data or pixel data is compressed and extended by the JPEG method. It, however, is not restricted by the JPEG method for compressing and extending the image data. Another data compression and extension method can be used.

Furthermore, in the above-mentioned embodiment, only one connector 25 is provided in the digital camera 1 so as to be connected not only the RS-232C cable but also the USB cable, and the cable judging portion 211d of the main controller 211 automatically senses the kind of the cable connected to the connector 25. When a plurality of connectors respectively corresponding to the kinds of the cables are provided in the camera body, it is possible to select the kind of the cable to be used by the user. In the latter case, it is possible to configure the program selecting portion 211h automatically for setting the communication interface 42 serving as the RS-232C interface or the USB interface corresponding to the selection of the cable.

Still furthermore, in the above-mentioned embodiment, the data compressor/extender 41 for compressing and extending the image data and the communication interface 42 for communicating the image data between the digital camera 1 and the personal computer 50 are configured by the FPGAs. It, however, is possible to configure the γ compensation circuit 206c and the filtering circuit 211i by the FPGAs, when a plurality of processes with respect to the quality of the image are respectively executed corresponding to different characteristics.

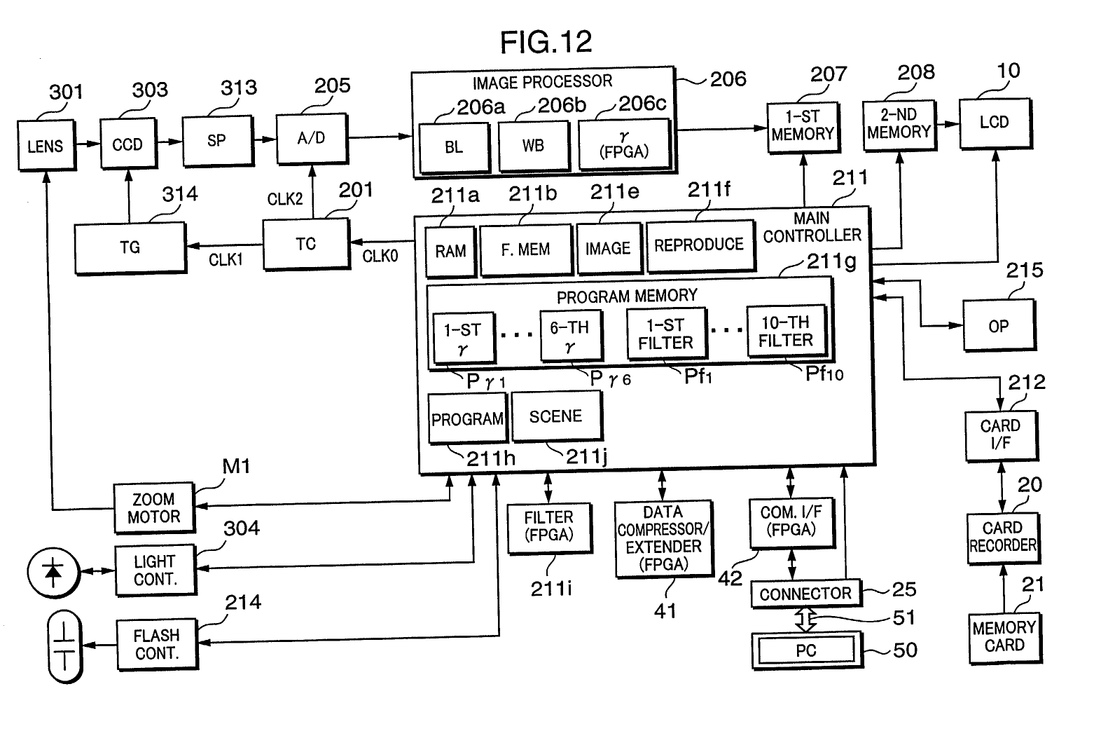

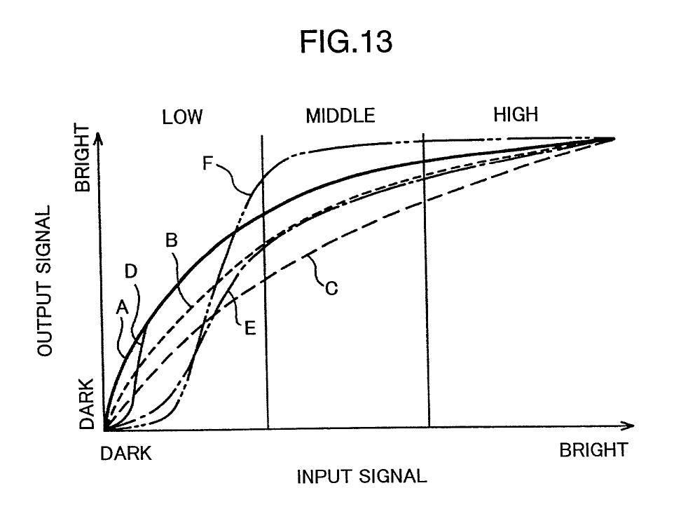

A modified block diagram of the digital camera 1 of this embodiment is shown in FIG. 12. In FIG. 12, the same numerals used in FIG. 8 designate the same elements. As shown in FIG. 12, the program memory 211g further memorizes first to sixth γ programs P_{γ1} to P_{γ6} corresponding to six kinds of γ characteristic curves “A” to “F” shown in FIG. 13 and first to tenth filter programs P_{f1} to P_{f10} corresponding to different compression ratios.

In FIG. 13, a characteristic curve designated by a symbol “A” (hereinafter called characteristic curve “A”, and the same rule applies correspondingly to the following) has a γ=0.45, and is used in the image data processing for displaying the image taken by the image pickup device 303 on the monitor display 10 having a characteristic of γ=2.2. The monitor display 10 serves as a viewfinder when the digital camera 1 is ready for shutter start. An optical image of an object is taken at interval of 1/30 sec by the image pickup device 303, and the optical images are serially displayed on the monitor display 10. In such the image data processing for monitoring image, it is possible to make the quality of the image displayed on the monitor display suitable by compensating the γ characteristic of the image data by following the characteristic curve “A”.

A characteristic curve “B” has a γ=0.55, and is used in the image data processing for recording an image data, which is taken under a normal condition where a luminance of an object is in a middle level and the object is illuminated by a follow light, in the memory card 21. In this embodiment, the digital camera 1 is communicative with the personal computer 50, so that an image data recorded in the memory card 21 is generally used for reproducing an image on a monitor display of the personal computer 50. Since the monitor display of the personal computer has a characteristic of γ =1.8, the characteristic curve “B” is used for compensating the image data to be recorded in the memory card 21 in a manner so that the quality of the image reproduced on the monitor display of the personal computer becomes proper.

Characteristic curves “C”, “D”, “E” and “F” are used in the image data processing for recording the image data in the memory card 21. The characteristic curves are varied corresponding to the scenes or the conditions so as to make the quality of the reproduced image proper when the image data are taken.

A value of the γ of the characteristic curve “C” is made smaller than that of the characteristic curve “B”. An inclination angle of the γ of the characteristic curve “D” in the vicinity of the dark end is made larger than that of the characteristic curve “A”. An inclination angle of the γ of the characteristic curve “E” in the low level region of the input signal is made larger than that of the characteristic curve “B”. Variation of the characteristic curve “F” in the middle and high level regions of the input signal is much smaller than that of the characteristic curve “A”, and an inclination angle of the γ of the characteristic curve “F” in the low level region of the input signal is made larger than that of the characteristic curve “C”.

The γ characteristic of the same image data is compensated by using the characteristic curves “A”, “C”, “D”, “E” and “F”, and the images of the compensated image data are reproduced on the monitor display of the personal computer 50. The qualities of the images corresponding to the image data compensated by the characteristic curves “C” to “F” are compared with respect to that compensated by the characteristic curve “A”.

The quality of the reproduced image compensated by the characteristic curve “C” becomes softer with a low contrast than that compensated by the characteristic curve “A”, but the resolution in a highlight portion becomes higher.

When the image data is compensated by the characteristic curve “D”, the contrast of the image becomes substantially the same as that compensated by the characteristic curve “A”. The inclination angle of the characteristic curve “D”, however, is larger than that of the characteristic curve “A” in the vicinity of the dark end, so that the dark portion of the reproduced image becomes sharp. When the image data obtained by exposure control of the gain control in a low illuminance scene is compensated by the characteristic curve “A”, the reproduced image generally becomes rough and dark. Thus, it is possible to prevent the deterioration of the quality of the reproduced image by compensating the image data by using the characteristic curve “D”.

When the image data is compensated by the characteristic curve “E”, the contrast of the image becomes lower than that compensated by the characteristic curve “A”. A range of conversion level of the characteristic curve “E”, however, is wider than that of the characteristic curve “A”in the low and middle level regions of the input signal, so that the tone in the highlight portion of the reproduce image is made preferable.

When the image data is compensated by the characteristic curve “F”, the contrast of the image becomes higher and the dark portion of the reproduced image becomes sharper than that compensated by the characteristic curve “A”.

In this embodiment, the γ programs P_{γ1} to P_{γ6} corresponding to the characteristic curves “A” to “F” are memorized in the program memory 211g. The program selecting portion 211h selects one among the γ programs P_{γ1} to P_{γ6} which is the most suitable to the scene and/or condition of the photographing, and enters the selected program into the γ compensation circuit 206c configured by the FPGA. Thus, the γ compensation circuit compensates the image data with using the most suitable γ characteristic to the scene and/or condition of the photographing.

The γ programs P_{γ1} to P_{γ6} are not directly execute the γ compensation of the image data, but they enable the FPGA to serve as a γ compensation circuit. For compensating the γ characteristic of the image data, one of the γ program P_{γ1} to P_{γ6} is entered into the γ compensation circuit 206c for serving as a dedicated IC having the most suitable γ characteristic to the scene and or condition of the photographing. Thus, it is possible that processing speed of the γ compensation in this embodiment can be made faster than that in the conventional γ compensation of the image by the software program. Alternatively, it is possible that the circuit configuration used for the γ compensation of the image data in this embodiment can be made simpler than that in the conventional circuits configured by the dedicated ICs.

Subsequently, contour compensation filtering processes in this modification are described. In this modification, five kinds of filtering processes including a normal contour compensation, two kinds of contour emphasizing from the normal contour compensation, and two kinds of contour unemphasizing from the normal contour compensation are executed with respect to the compression ratios K=⅛ and K=1/20 corresponding to the compression ration set by the compression ratio setting switch 17 and the scene of the photographing judged by the scene judging portion 211j.

When the compression ratio K=⅛, the filtering processes of each pixel data G(i, j) is executed by using the following equation (1). When the compression ratio K=1/20, the filtering processes of each pixel data G(i, j) is executed by using the following equation (2). In the equations (1) and (2), symbols A1 to A21 are filtering coefficients.

$$\begin{matrix}G ( i , j ) = \{ A1 \cdot G ( i , j ) + A2 \cdot G ( i + 1 , j ) + A3 \cdot G ( i + 1 , j + 1 ) + A4 \cdot G ( i , j + 1 ) + A5 \cdot G ( i - 1 , j + 1 ) + A6 \cdot G ( i - 1 , j ) + A7 \cdot G ( i - 1 , j - 1 ) + A8 \cdot G ( i , j - 1 ) + A9 \cdot G ( i + 1 , j - 1 ) + A10 \cdot G ( i + 2 , j ) + A11 \cdot G ( i , j + 2 ) + A12 \cdot G ( i - 2 , j ) + A13 \cdot G ( i , j - 2 ) \} / B & ( 1 ) \\ G ( i , j ) = \{ A1 \cdot G ( i , j ) + A2 \cdot G ( i + 1 , j ) + A3 \cdot G ( i + 1 , j + 1 ) + A4 \cdot G ( i , j + 1 ) + A5 \cdot G ( i - 1 , j + 1 ) + A6 \cdot G ( i - 1 , j ) + A7 \cdot G ( i - 1 , j - 1 ) + A8 \cdot G ( i , j - 1 ) + A9 \cdot G ( i + 1 , j - 1 ) + A10 \cdot G ( i + 2 , j ) + A11 \cdot G ( i , j + 2 ) + A12 \cdot G ( i - 2 , j ) + A13 \cdot G ( i , j - 2 ) + A14 \cdot G ( i + 1 , j - 2 ) + A15 \cdot G ( i + 2 , j - 1 ) + A16 \cdot G ( i + 2 , j + 1 ) + A17 \cdot G ( i + 1 , j + 2 ) + A18 \cdot G ( i - 1 , j + 2 ) + A19 \cdot G ( i - 2 , j + 1 ) + A20 \cdot G ( i - 2 , j - 1 ) + A21 \cdot G ( i - 1 , j - 2 ) \} / B & ( 2 )\end{matrix}$$

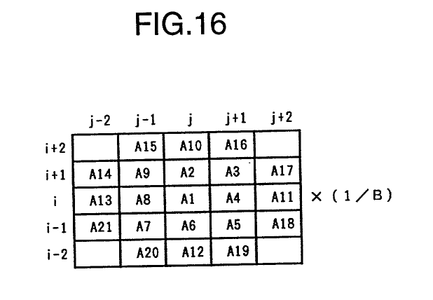

FIG. 16 shows an arrangement of the filtering coefficients A1 to A21 with respect to one pixel at a position (i, j). As can be seen from FIG. 16, the center pixel at the position (i, j) and twenty four pixels surrounding thereto configure a matrix of 5×5 boxes, and the filtering coefficients A1 to A21 are arranged as shown in the figure. A symbol “B” in FIG. 16 corresponds to the denominators “B” in the equations (1) and (2).

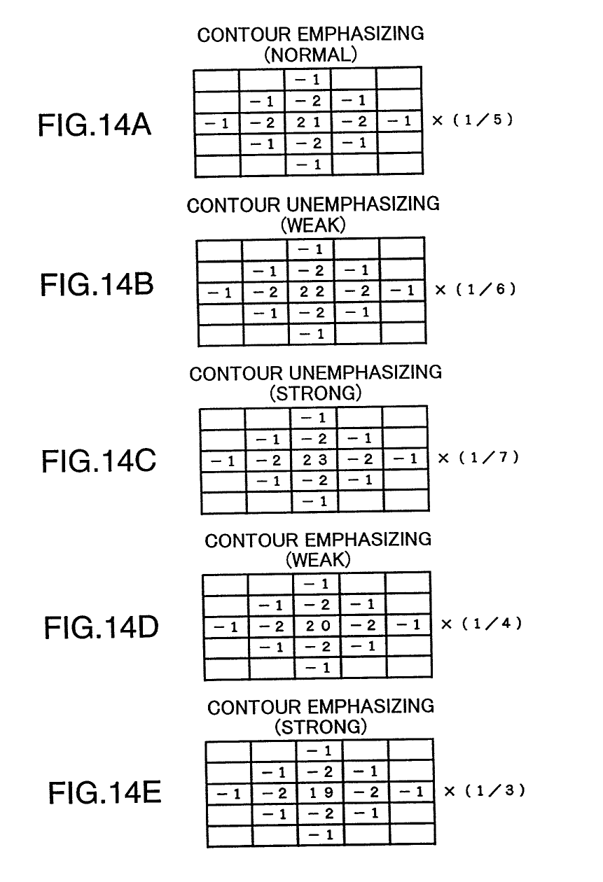

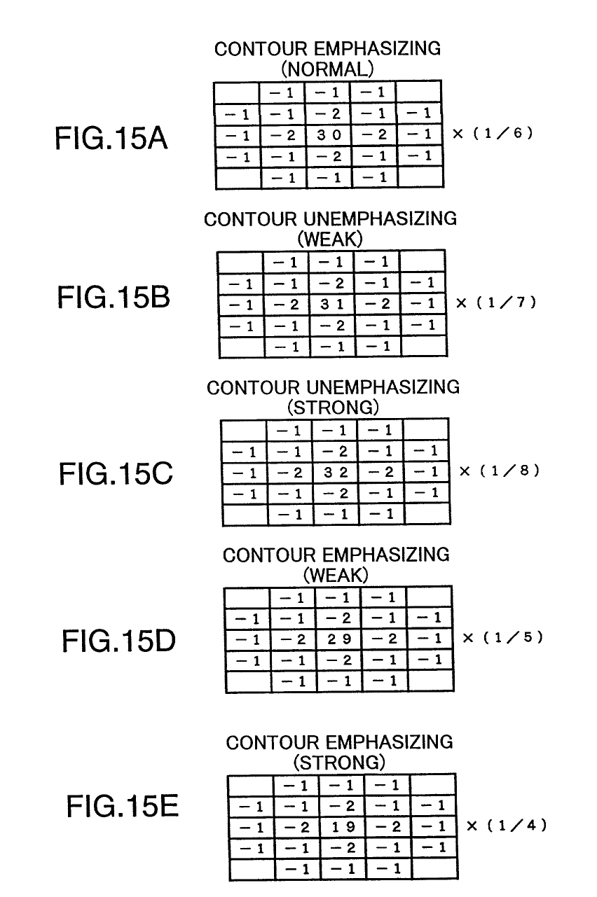

FIGS. 14A to 14E respectively show five examples of the values of the filtering coefficients A1 to A21 with respect to the compression ratio K=⅛. FIGS. 15A to 15E respectively show five examples of the values of the filtering coefficients A1 to A21 with respect to the compression ratio K=1/20.

FIGS. 14A and 15A respectively correspond to the normal contour emphasizing compensation. FIGS. 14B and 15B respectively correspond to the contour unemphasizing compensation de-escalated with one step from the normal contour emphasizing compensation. FIGS. 14C and 15C respectively correspond to the contour unemphasizing compensation de-escalated with two steps from the normal contour emphasizing compensation. FIGS. 14D and 15D respectively correspond to the contour emphasizing compensation escalated with one step from the normal contour emphasizing compensation. FIGS. 14E and 15E respectively correspond to the contour emphasizing compensation de-escalated with two steps from the normal contour emphasizing compensation.

In this embodiment, the filter programs P_{f1} to P_{f10} corresponding to the above-mentioned ten kinds of the contour emphasizing filtering processes are memorized in the program memory 211g. The program selecting portion 211h selects one among the filter programs P_{f1} to P_{f10} corresponding to the compression ratio K, and enters the selected program into the filtering circuit 211i configured by the FPGA. Thus, the filtering circuit 211i compensates the image data with using the filtering ratios A1 to A21 most suitable for contour emphasizing compensation.

The filter programs P_{f1} to P_{f10} are not directly execute the contour emphasizing compensation of the image, but they enable the FPGA to serve as a filtering compensation circuit. For filtering the image data for the contour emphasizing compensating of the image, one of the filter program P_{f1} to P_{f10} is entered into the filtering circuit 211i for serving as a dedicated IC having the most suitable filtering characteristic to the scene and or condition of the photographing. Thus, it is possible that processing speed of the filtering process for the contour emphasizing compensation in this embodiment can be made faster than that in the conventional filtering process by the software program. Alternatively, it is possible that the circuit configuration used for the filtering process for the contour emphasizing compensation of the image in this embodiment can be made simpler than that in the conventional circuits configured by the dedicated ICs.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A camera comprising:
a mode selector for selecting one of a first mode for executing a first image data processing to an image data taken by an image pickup device and a second mode for executing a second image data processing contents of which are different from that of the first image data processing;
a calculator in which a logic circuit for executing a predetermined operation to an inputted image data when a predetermined program is written;
a memory for memorizing a first program corresponding to the first image data processing and a second program corresponding to the second image data processing; and
a controller for reading the first program from the memory and writing it in the calculator when the first mode is selected by the mode selector and for reading the second program from the memory and writing it in the calculator when the second mode is selected by the mode selector.

2. The camera in accordance with claim 1, wherein
the first mode is an image pickup mode for taking an image data by photoelectric transferring an optical image of an object;
the second mode is a reproducing mode for reproducing an image on a display by using an image data taken by the image pickup mode;
the first image data processing is a data compression processing of the image data taken by the image pickup mode; and
the second image data processing is a data extension processing of a compressed image data.

3. The camera in accordance with claim 1, wherein the calculator is a field programmable gate array.

4. A camera comprising:
a connection portion to which a first equipment and a second equipment can alternatively be connected, the first equipment be communicative a data with the camera by a first data communication standard, and the second equipment be communicative a data with the camera by a second data communication standard;
a detector for judging a kind of data communication standard of an equipment connected to the connection portion;
a calculator in which a logic circuit for executing a predetermined operation to an inputted image data when a predetermined program is written;
a memory for memorizing a first program corresponding to a first image data communication processing fitting for the first data communication standard and a second program corresponding to a second image data communication processing fitting for the second data communication standard; and
a controller for reading the first program from the memory and writing it in the calculator when the kind of the data communication standard of the equipment connected to the communication portion is judged as the first data communication standard by the detector and for reading the second program from the memory and writing it in the calculator when the kind of the data communication standard of the equipment is judged as the second data communication standard.

5. The camera in accordance with claim 4, wherein the first data communication standard and the second data communication standard are respectively a USB standard and an RS-232C standard.

6. The camera in accordance with claim 4, wherein the equipment to be connected to the connection portion is an equipment which can execute an image data processing.

7. The camera in accordance with claim 4, wherein the calculator is a field programmable gate array.

8. A camera comprising:
an image processing selector for selecting an image processing among a plurality of image processing corresponding to different characteristics with respect to quality of an image;
a calculator in which a logic circuit for executing a predetermined operation to an inputted image data when a predetermined program is written;
a memory for memorizing a plurality of programs corresponding to the plurality of image processing; and
a controller for reading a program corresponding to the image processing selected by the image processing selector and writing it in the calculator.

9. The camera in accordance with claim 8, wherein the image processing with respect to the quality of the image is a gamma compensation.

10. The camera in accordance with claim 8, wherein the image processing with respect to the quality of the image is a contour emphasizing or unemphasizing compensation of the image.

11. The camera in accordance with claim 8, wherein the calculator is a field programmable gate array.
